(19) United States
(12) Patent Application Publication
(10) Pub. No.: US 2006/0013279 A1
(43) Pub. Date: Jan. 19, 2006

(54) Grain moisture meter

(75) Inventor: Robert Funk, Auburn, IL (US)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Perten Instruments Inc., Springfield, IL (US)

(21) Appl. No.: 10/710,474

(22) Filed: Jul. 14, 2004

(51) Int. Cl. G01K 13/00

(52) U.S. Cl. 374/16; 374/142

(57) ABSTRACT

The present invention relates to a grain moisture meter comprising means (1,2) for introducing a grain sample into a test cell (3), said test cell comprising means for measuring the dielectric constant of the grain sample, and means for calculating the moisture content of said sample based on the measured dielectric constant. According to the invention the grain moisture meter comprises a strike off element (7) for removing excess of grains delivered to the test cell (3), a bottom container (4) disposed under the test cell (3) and having such an extension that grains removed from the test cell (3) by the strike off element (7) will fall into said container (4), means for unloading grains from the test cell into said container (4), and means (5) for weighing the container and its possible content.

### TECHNICAL BACKGROUND

The present invention relates to a grain moisture meter comprising means for introducing a grain sample into a test cell, said test cell comprising means for measuring the dielectric constant of the grain sample, and means for calculating the moisture content of said sample based on the measured dielectric constant. The invention also relates to a means for determining the temperature of a grain sample and a method for determining the density of a grain sample using such a grain moisture meter.

Grain, such as cereals, oilseeds and seeds, is bought and sold on the basis of weight. However, the actual value of the grains is in a dry state, which means that the moisture content of the grains must be taken account of when determining the price for a certain lot of grains. Furthermore, if the moisture content is above a certain value the risk for deterioration of the grains due to microbial activity makes it necessary to dry the grains before storage thereof. It is thus essential to be able to determine the moisture content of grains in an easy and accurate way.

Grain moisture meters based on the radio-frequency (RF) dielectric method measure moisture content in grain by sensing the dielectric constant of grain samples. However, it has been shown that grain kernel structure and composition and moisture distribution within kernels greatly influence the measurements, thereby making it necessary for individual calibration equations for different grain types and limiting the measurement accuracy. In “An investigation of the nature of the radio-frequency dielectric response in cereal grains and oilseeds with engineering implications for grain moisture meters” presented to the faculty of the University of Missouri-Kansas City by David. B. Funk it is shown that the RF-method can be used with the same calibration equations for all types of grains if measurement frequencies in the range 100-200 MHz are used instead of the commonly used range 1-20 MHz.

The accuracy of obtained moisture content values calculated from the measured dielectric constant of a grain sample introduced into a grain moisture meter is dependent several factors, such as temperature and grain density.

The objective of the present invention is to improve the accuracy of the measurements in a grain moisture meter based on the RF-method.

### SUMMARY OF THE INVENTION

This objective is accomplished by a grain moisture meter comprising means for introducing a grain sample into a test cell, said test cell comprising means for measuring the dielectric constant of the grain sample, and means for calculating the moisture content of said sample based on the measured dielectric constant, said meter further including a strike off element for removing excess of grains delivered to the test cell, a bottom container disposed under the test cell and having such an extension that grains removed from the test cell by the strike off element will fall into said container, means for unloading grains from the test cell into said container, and means for weighing the container and its possible content.

In a preferred embodiment the means for introducing a grain sample into a test cell comprises a top container comprising means for determining temperature of the grain sample. Furthermore, the meter comprises means for transporting the container from a delivery position, in which the container is accessible to an operator of the meter, to a loading position, in which the container is disposed on the weighing means and inaccessible to an operator of the meter.

The means for determine temperature of a grain sample comprise at least one elongate conductive element having a resistance dependent on the temperature and being bent in a pattern so that it covers a certain area, a sensor for measuring the current flowing in the conductive element and means for calculating the resistance of the conductive element based on the measured current and the temperature based on the calculated resistance value. In a preferred embodiment said means comprise also a second elongate element similar to the first conductive element and running parallel thereto and in the same plane. Advantageously, the at least one elongate conductive element runs in a meandering path and is made of copper.

The present invention also relates to a method of determining density of a grain sample, comprising the steps of;filling a test cell having a known volume with an excess of grains,removing the excess of grains from the test cell,gathering the removed excess grains in a container having a known weight when empty,weighing the container together with the excess grains,filling the container with grains from the test cell after the step of weighing the container together with the excess grains has been performed and weighing the container together with its content of grains,determining a correction factor for the density of the grains, said factor being dependent on the weight of the excess grains, and calculating the density of the grains.Description of Drawings

The invention will now be described with reference to the enclosed figures, of which;

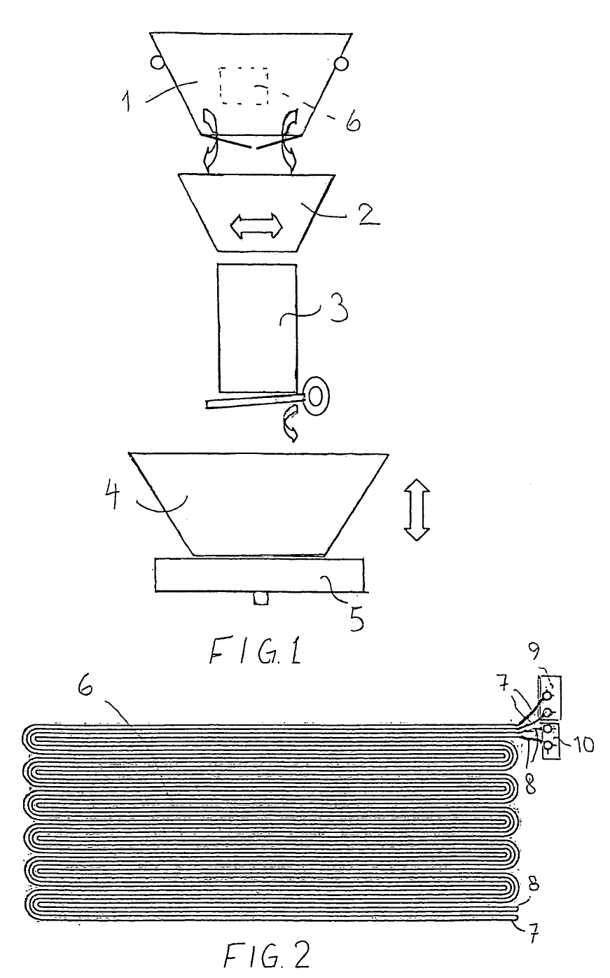

FIG. 1 schematically discloses a side view of an embodiment of a grain moisture meter according to the invention, and

FIG. 2 schematically discloses a temperature sensor disposed in the top hopper of the meter shown in FIG. 1.

### DESCRIPTION OF EMBODIMENTS

The grain moisture meter shown in FIGS. 1 and 2 comprises a top hopper 1, a strike off element 2, a test cell 3 and a container 4 disposed on a balance 5.

The top hopper 1 functions to hold a grain sample during a temperature measurement thereof and then emptying the grain sample into a test cell 3 via a funnel element 2 provide with a strike off element 7. In order to measure the temperature of the grain sample, a temperature meter 6 is disposed in the top hopper 1.

The temperature meter 6 is schematically shown in FIG. 2. It consists of two threads of conductive material 7 and 8, respectively, being bent in a meandering path and running parallel to each other. The resistance of each thread varies with the temperature, the dependency being quite linear within the temperature range in question. The threads 7,8 are preferably encapsulated in an insulating material, for example Kapton. The threads 7,8 are connected to a respective sensor 9 and 10, sensing the current flowing in the thread. The temperature is then calculated on the basis of the measured current value by the sensor itself or by a CPU or the like connected to the sensors. Sensors of this type are commercially available.

This temperature meter can be constructed inexpensively with the use of standard flex-circuit processing similar to the processing of flat cables used in moving-head inkjet printers. The meandering threads 7,8 can be held in a plastic frame and secured thereto by a suitable adhesive or by a solder connection. Such a temperature meter is of robust construction and functions properly in the presence of dust, moisture, rough handling and loads and abrasive forces from a flow of grains.

The threads 7,8 can be made of copper having a positive temperature coefficient of 0.42% increase in resistance per ° C. and with a total resistance of 3.5 ohms. The copper threads can be about 0.04 mm thick and 0.25 mm wide having an insulation of about 0.05 mm providing good abrasion resistance. Such a temperature meter will have an area of about 25 square cm and will therefore be in contact with a great number of grains. This is advantageous for obtaining an accurate average overall sample temperature, particularly if the sample has been blended from various points within a truck or bin before it is filled into the top hopper 1.

After the temperature of a grain sample in the top hopper 1 has been measured the bottom of the hopper is opened by any suitable mechanism and the grain sample is emptied into the test cell 3 having an open top. On its way to the test cell 3, the grain sample is guided by a funnel element 2.

The grain sample filled into the top hopper 1 should take up a somewhat larger volume than the volume of the test cell 3 so that it is ensured that all space in the test cell is filled by grains from the grain sample. The excess of grains is struck off by a strike off element 7, which is indicated schematically by an arrow in figure and movable in a transverse direction by any suitable mechanism. The strike off element 7 can for example be a blade or the like driven by an endless belt or the like.

The excess grain struck off from the top of test cell 3 falls down into a container 4 arranged under the test cell 3 and having such an extension in a horizontal plane that it is ensured that all excess grain will fall into this container 4.

In test cell 3 the dielectric constant of the grain sample is measured and this value is used for calculating the moisture content in the grain sample. The dielectric constant is measured by the RF-method with use of known equipment therefore. Such measurements and equipment are well known to a skilled man and need not be described further. It is enough to say that the measurements preferably are made in the range of 100-250 MHz. In “An investigation of the nature of the radio-frequency dielectric response in cereal grains and oilseeds with engineering implications for grain moisture meters” presented to the faculty of the University of Missouri-Kansas City by David. B. Funk it is shown that the RF-method can be used with the same calibration equations for all types of grains if this range is used.

After the dielectric constant of the grain sample has been measured, the test cell 3 is emptied by opening the bottom thereof by any suitable opening mechanism. The grain sample then falls into the container 4 disposed under the test cell.

In order to be able to calculate the moisture content with the aid of the measured dielectric constant, the density of the grain sample must be known as well as the temperature thereof. The volume of the interior space of the test cell is known so the density of the grain sample occupying this volume can be determined by weighing the grain sample in the container 4. For this purpose container 4 is placed on weighing means 5, such as a weighing table, a load cell platform, a balance or the like.

The weight of the grain sample within the test cell 3 is easily determined by weighing the container 4 three times for each grain sample, namely before excess of grain sample is removed from the top of the test cell (determining tare weight), before the grain sample in the test cell is emptied into container 4 (determining the weight of the excess of grain sample), and finally after the grain sample in the test cell has been emptied into container 4 (determining weight of the grain sample in the test cell).

This indirect way of determining the weight of the grain sample has several advantages in comparison with the common direct way of determining the weight by measuring a test cell empty and filled with grain sample. Firstly, by weighing the excess of grain sample removed from the top of the test cell 3, a proper filling of the test cell can be verified. If the excess of grain sample is non-existent or very small, this indicates that the test cell is not properly filled. Furthermore, the packing degree of the grain sample is proportional to the height of the column of grain filled into the test cell. Thus, the packing degree will increase proportionally to an increase of the excess of grain sample. By determining the weight of the excess of grain sample, a correlation factor taking the packing degree into consideration can be calculated and used when determining the density of the grain sample in the test cell 3.

Another error that is avoided by using container 4 is the weight “hysteresis effect” of the cabling to the test cell if this cell would be weighed. Electrical connections to the test cell are unavoidable. These connections use wires that are stiff enough to influence the weighing accuracy. By the present invention a separate container 4 having no mechanical or electrical connections to the remaining part of the moisture meter is used and no “hysteresis effect” can thus occur during the weighing.

The weight of the container 4 is furthermore much lower than the weight of the test cell, which enables more sensitive sample weight measurements to be performed.

The grain moisture meter according to the present invention preferably comprises means (not shown in the figures) for transporting the container 4 from a delivery position, in which the container is accessible to an operator of the meter, to a loading position, in which the container is disposed on the load cell platform 5 or other types of weighing means and inaccessible to an operator of the meter. Thereby it is ensured that an operator of the meter can not influence the weight readings and that the container will be gently transferred to the load cell platform. The transport means can be a lift mechanism lowering the container 4 gently onto the platform 5 or any other suitable transport mechanism, as indicated by a double arrow in FIG. 1.

An electronic tilt sensor is preferably monitoring the orientation of the grain moisture meter. Thereby, small deviations from a vertical orientation of the load cells can be compensated for mathematically, thereby eliminating the need for adjustable levelling feet on the meter.

The grain moisture meter comprises also a CPU or the like for controlling the different measurements steps and for performing the required calculations. This CPU can be a separate computer connected to the rest of the meter or a CPU integral with the rest of the meter.

The described embodiment can of course be modified in several ways without falling outside the scope of invention. For example, instead of a separate blade 7, the strike off element can be the funnel 2, the funnel 2 then being movable in a transverse direction from a central position. An advantage with such a construction is that the excess of grain sample will be fairly evenly distributed in the container 4. Furthermore, instead of swingable doors to open the bottoms of top hopper 1 and/or the test cell 3, slidable doors can be used. If slidable doors are used for the top container 1, the funnel element 2 can be deleted, a separate strike off element then be used or the top hopper being moveable in a transverse direction to function also as a strike off element. Other temperature meters than the meter 6 can of course be used for measuring the temperature of the grain sample. The scope of protection shall therefore only be determined by the wording of the enclosed patent claims.

1. A grain moisture meter comprising means (1,2) for introducing a grain sample into a test cell (3), said test cell comprising means for measuring the dielectric constant of the grain sample, and means for calculating the moisture content of said sample based on the measured dielectric constant, said meter further including a strike off element (7) for removing excess of grains delivered to the test cell (3), a bottom container (4) disposed under the test cell (3) and having such an extension that grains removed from the test cell (3) by the strike off element (7) will fall into said container (4), means for unloading grains from the test cell into said container (4), and means (5) for weighing the container and its possible content.

2. The meter according to [c1], wherein the means (1,2) for introducing a grain sample into a test cell comprises a top container (1) comprising means (6) for determining temperature of the grain sample.

3. The meter according to [c1], wherein it comprises means for transporting the bottom container (4) from a delivery position, in which the container is accessible to an operator of the meter, to a loading position, in which the container is disposed on the weighing means (5) and inaccessible to an operator of the meter.

4. Means for determining temperature of a grain sample, wherein said means (6) comprise at least one elongate conductive element (7,8) having a resistance dependent on the temperature and being bent in a pattern so that it covers a certain area, a sensor (9,10) for measuring the current flowing in the conductive element (7,8) and means for calculating the resistance of the conductive element based on the measured current and the temperature based on the calculated resistance value.

5. Means according to [c4], wherein said means (6) comprise a second elongate element (8) similar to the first conductive element (7) and running parallel thereto and in the same plane.

6. Means according to [c4] wherein the at least one elongate conductive element (7,8) runs in a meandering path.

7. Means according to [c4], wherein the at least one elongate conductive element (7,8) is made of copper.

8. Method of determining density of grains, comprising the steps of: (a) filling a test cell (3) having a known volume with an excess of grains, (b) removing the excess of grains from the test cell (3), (c) gathering the removed excess of grains in a container (4) having a known weight when empty, (d) weighing the container (4) together with the excess of grains, (e) filling the container (4) with grains from the test cell (3) after the step of weighing the container (4) together with the excess of grains has been performed and weighing the container (4) together with its content of grains, (f) determining a correction factor for the density of said grains, said factor being dependent on the weight of the excess of grains, and (g) calculating the density of the grains.
